(19) United States
(12) Patent Application Publication
(10) Pub. No.: US 2011/0294542 A1
(43) Pub. Date: Dec. 1, 2011

(54) CELL PHONE COVER WITH INTEGRATED MIRROR AND FLIP SHIELD

(75) Inventors: Frances RAY, Loudonville, NY (US); Becky KASSELMAN, Delmar, NY (US)

(73) Assignee: EDGY ANGEL PRODUCTIONS LLC, Loudonville, NY (US)

(21) Appl. No.: 12/788,886

(22) Filed: May 27, 2010

(51) Int. Cl. H04W 88/02; H04B 1/38; H04M 1/00

(52) U.S. Cl. 455/556.1; 455/575.8; 455/90.3

(57) ABSTRACT

The present invention provides a cellular phone cover with a flip shield to protect a mirror from scratches and damage. The cellular phone cover may include a sheath configured with an opening to provide access to a user interface, a mirror attached to the sheath, and a shield attached to the sheath. A cellular phone system is also provided which may include a cellular phone, a sheath, a mirror, and a shield. A method of adapting a cellular phone including providing a sheath, attaching a mirror to the sheath, and providing a shield is also provided.

### TECHNICAL FIELD

The invention relates generally to the field of cellular phones, and more specifically, to cellular phone covers.

### BACKGROUND OF THE INVENTION

Cellular phones are often kept in pockets and purses along with may other items. These other items may include keys, mirrors, pens, pencils, paper, tissues, handkerchiefs, candy, medicine, glasses, make-up, and personal items an individual frequently uses. The considerable number of items can lead to clutter in pockets and purses, and some of the items may become damaged when they come into contact with one another.

Accordingly, reducing the clutter present in purses and pockets and protecting commonly carried items from damaging one another is desirable.

### SUMMARY OF THE INVENTION

The cell phone cover of the present invention reduces the number of items which may be carried and protects items from damage.

The invention provides, in one aspect, a cellular phone cover, having a sheath configured to receive and retain a cellular phone, the sheath configured with an opening to allow unobstructed access to a user interface of the phone, a mirror attached to the sheath, and a shield, positioned to protect the mirror from scratches and other damage, attached to the sheath. In one embodiment, the invention provides for the back side of the mirror to face the phone so that the reflective side faces away from the phone. Apertures may be formed on the sheath to provide access to buttons, sockets, and charging means. A hinge may be formed between the sheath and the shield, and in one embodiment the hinge is provided at the bottom of the sheath and shield. A light is also provided in another embodiment of the invention; the light may be positioned behind the mirror, or about the perimeter of the mirror.

The invention provides, in another aspect, a cellular phone system, having a cellular phone, a sheath covering the cellular phone and configured to allow unobstructed access to a user interface of the phone, a mirror attached to the sheath, and a shield, positioned to protect the mirror from scratches and other damage, attached to the sheath. In one embodiment, the invention provides for the back side of the mirror to face the phone so that the reflective side faces away from the phone. Apertures may be formed on the sheath to provide access to buttons, sockets, and charging means. A hinge may be formed between the sheath and the shield, and in one embodiment the hinge is provided at the bottom of the sheath and shield. A light is also provided in another embodiment of the invention; the light may be positioned behind the mirror, or about the perimeter of the mirror.

The invention provides, in another aspect, a method of adapting a cellular phone including, providing a sheath for covering a cellular phone, the sheath configured with an opening to allow unobstructed access to a user interface of the phone, attaching a mirror to the sheath, and providing a shield positioned to protect the mirror from scratches and other damage. In one embodiment of the invention, the mirror may be positioned beneath the surface of the sheath where the back side of the mirror faces the cellular phone.

Other additional features and benefits will become apparent from the following drawings and descriptions of the invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the end of the specification. The foregoing and other objects, features, and advantages of the invention are apparent from the following detailed description taken in conjunction with the accompanying drawings in which:

FIG. 1 is a perspective view of one embodiment of a cellular phone system, in accordance with an aspect of the invention;

FIG. 2 is a bottom elevation view of the cellular phone system of FIG. 1, in accordance with an aspect of the invention;

FIG. 3 is a rear elevation view of the cellular phone system of FIG. 1, in accordance with an aspect of the invention;

FIG. 4 is a side elevation view of an alternative embodiment of the cellular phone system of FIG. 1, in accordance with an aspect of the invention;

FIG. 5 is a side elevation view of an alternative embodiment of the cellular phone system of FIG. 1, in accordance with an aspect of the invention;

FIG. 6 is a side elevation view of an alternative embodiment of the cellular phone system of FIG. 1, in accordance with an aspect of the invention;

FIG. 7 is a rear elevation view of an alternative embodiment of the cellular phone system of FIG. 1, in accordance with an aspect of the invention;

FIG. 8 is a rear elevation view of an alternative embodiment of the cellular phone system of FIG. 1, in accordance with an aspect of the invention.

### DETAILED DESCRIPTION FOR CARRYING OUT THE INVENTION

For the purposes of promoting an understanding of the principles of the cellular phone cover and cellular phone system, reference will now be made to the embodiments, or examples, illustrated in the drawings and specific language will be used to describe these. It will nevertheless be understood that no limitation of the scope of the invention is thereby intended. Any alterations and further modifications in the described embodiments, and any further applications of the principles of the invention as described herein are contemplated as would normally occur to one skilled in the art to which the cellular phone cover and cellular phone system invention relates.

Generally stated, disclosed herein is a cellular phone cover for use in a cellular phone system. The cellular phone cover and system shown herein are intended for example purposes only, as many alterations would occur to one skilled in the art, and are contemplated as a part of the invention. The cellular phone cover includes, generally, a sheath configured to receive and retain a cellular phone, and configured with an opening to allow unobstructed user access to a user interface of the phone, a mirror attached to the sheath, and a shield attached to the sheath and positioned to protect the mirror from scratches and other damage. The cellular phone system generally includes a cellular phone, a sheath, configured with an opening to allow unobstructed access to a user interface, covering the cellular phone, a mirror attached to the sheath, and a shield attached to the sheath and positioned to protect the mirror from scratches and other damage. Generally stated, a method of adapting a cellular phone includes, providing a sheath for covering the cellular phone, where the sheath is configured with an opening to allow unobstructed access to a user interface, attaching a mirror to said sheath and providing a shield positioned to protect the mirror from scratches and other damage.

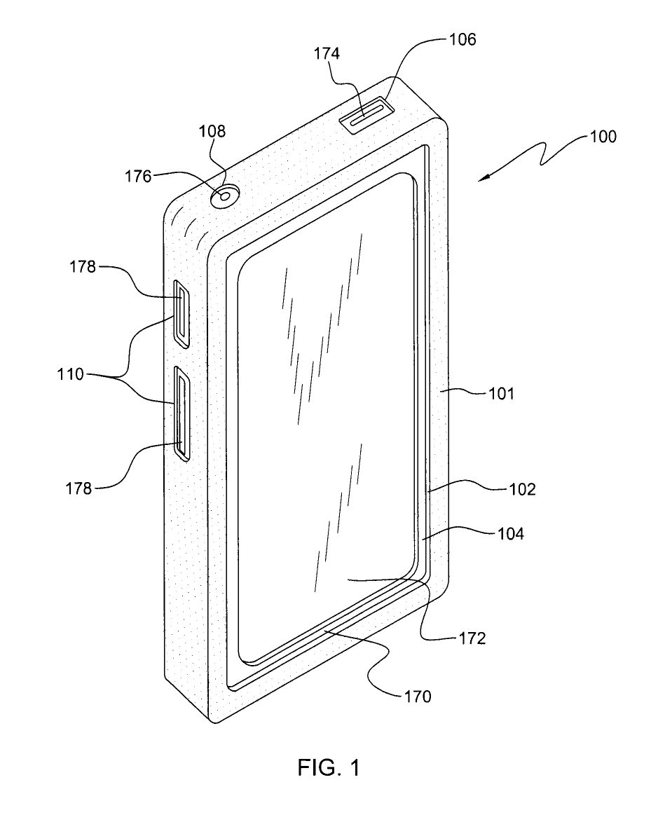

The cellular phone shown in FIGS. 1-8 and described herein is a touch screen phone. It should be understood that the invention could equally apply to other types of cellular phones, such as phones with an international standard keypad, a QWERTY keyboard pad, or other types of keypad, as well as flip cellular phones, sliding cellular phones, and other types of cellular phones.

As used herein, the terms “cellular phone”, “cell phone” and “phone” may be used interchangeably as they refer to the same type of device.

An embodiment of the cellular phone system of the invention is identified in FIGS. 1-8 by reference number 100. An embodiment of the cellular phone cover of the invention is identified in FIGS. 1-8 by reference number 101.

Referring now to FIG. 1, cellular phone cover 101 may be comprised of a sheath 102. Cellular phone system 100 is also shown in FIG. 1, and may be comprised of cellular phone cover 101 and a cell phone 170. Opening 104 is formed in sheath 102 and provides access to a user interface 172 of phone 170. An aperture 106 may be formed on sheath 102 to provide access to a switch 174 of phone 170. Switch 174 may be an on-off switch, a hold switch, or another known type of switch present on cellular phones. Aperture 106 is shown formed on the top of sheath 102. However, in alternative embodiments, it is contemplated that aperture 106 may be formed on the sides, bottom, front or back of sheath 102. An aperture 108 is formed on sheath 102 to provide access to a socket 176. Socket 176 and aperture 108 may be adapted to receive a headphone, speaker, microphone, television, Bluetooth, earbud or other known electronic jack. One or more apertures 110 may be formed on sheath 102. Apertures 110 may be formed on the sides top bottom front or back of sheath 102. Apertures 110 permit sheath 102 to be placed on a phone 170 such that buttons 178 are not depressed when sheath 102 is in place. Buttons 178 may control the speaker or ringer volume, a camera function, a microphone, a hands free functionality, or other function commonly incorporated into cellular phones. It is contemplated that sheath 102 helps to protect phone 170 as well as protect and support a mirror.

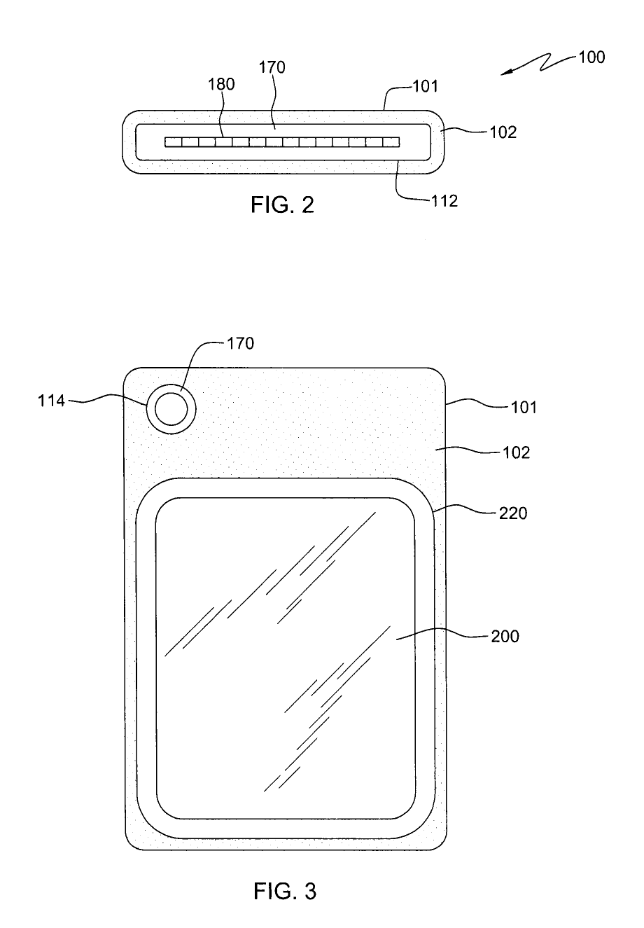

Referring now to FIG. 2, a bottom view of cellular phone cover 101 and cellular phone system 100 is shown. An aperture 112 for providing access to a charging means 180 is provided in the bottom of sheath 102. Aperture 112 is configured to allow a user of phone 170 and cover 101 to attach a charger to charging means 180. The shape and size of aperture 112 and charging means 180 are shown for illustrative purposes. Many different charging means 180 are available in a variety of plug and adapter sizes. Thus, one skilled in the art would recognize that aperture 112 may be sized to accommodate this variety of charger shapes and sizes. Further, given that cellular phones come in a variety of different shapes and sizes, the aperture for receiving the charger may be located on the front, back, sides or top of sheath 102.

Opening 104 and apertures 106, 108, 110 and 112 may be configured in different locations and orientations on sheath 102. Different configurations may be available for different types of cellular phones. Opening 104 and apertures 106, 108, 110 and 112 may be designed to provide access to the user interface and other functional parts of phone 170. It is contemplated that, where phone 170 does not have a switch, socket, buttons, or charging means, apertures 106, 108, 110 and 112 may be omitted. If sheath 102 is constructed in a manner and out of a material that allows a user to depress the buttons through sheath 102, it is contemplated that apertures 110 may be omitted. Opening 104 and apertures 106, 108, 110 and 112 are configured to provide easy manipulation by the user, and configured such that sheath 102 does not interfere with the ordinary use of phone 170.

Referring to FIG. 3, a rear view of cellular phone cover 101 and cellular phone system 100 is shown. An aperture 114 may be formed in sheath 102. Aperture 114 is sized and appropriately located such that the lens for a camera is unobscured by sheath 102. It should be understood that aperture 114 may also be located on the front of sheath 102 if a camera lens is located on the front of phone 170. Aperture 114 is configured such that the camera function of phone 170 is not inhibited in any way by the placement of sheath 102 over phone 170.

Still referring to FIG. 3, a mirror 200 is shown attached to sheath 102. Shield 220 is shown positioned over mirror 200 to protect mirror 200 from scratches and damage. It is contemplated that a reflective side of mirror 200 faces away from phone 170. Thus, mirror 200 may be positioned on the surface of sheath 102 and the back side of mirror 200 faces phone 170. As shown in FIG. 3, shield 220 may be integrally attached to sheath 102. If shield 220 is integrally attached to sheath 102, it is contemplated that shield 220 may be transparent, and does not inhibit the function of mirror 200. In alternative embodiments, it is contemplated that shield 220 may be translucent or otherwise affect the transmission of light if such an effect is desired. For example purposes only, shield 220 may be rose, aqua, yellow or any other suitable color. It is contemplated that, in this embodiment, shield 220 protects mirror 200 from damage while allowing the transmission of light, at least in part.

It is contemplated that mirror 200 may be removably attached to sheath 102. For example purposes, sheath 102 may be configured such that mirror 200 may be placed under shield 220. It is contemplated that a slot or socket which may provide access to a compartment may be formed on sheath 102. The compartment may be located under shield 220, and be configured to receive and retain mirror 200. It is contemplated that this may provide for easier assembly of cellular phone cover 101 and cellular phone system 100. It is also contemplated that mirror 200 may be removable or replaceable within sheath 102. Further, mirror 200 may be replaced if it becomes damaged, dirty or worn, or if the user desires to replace it with a different mirror.

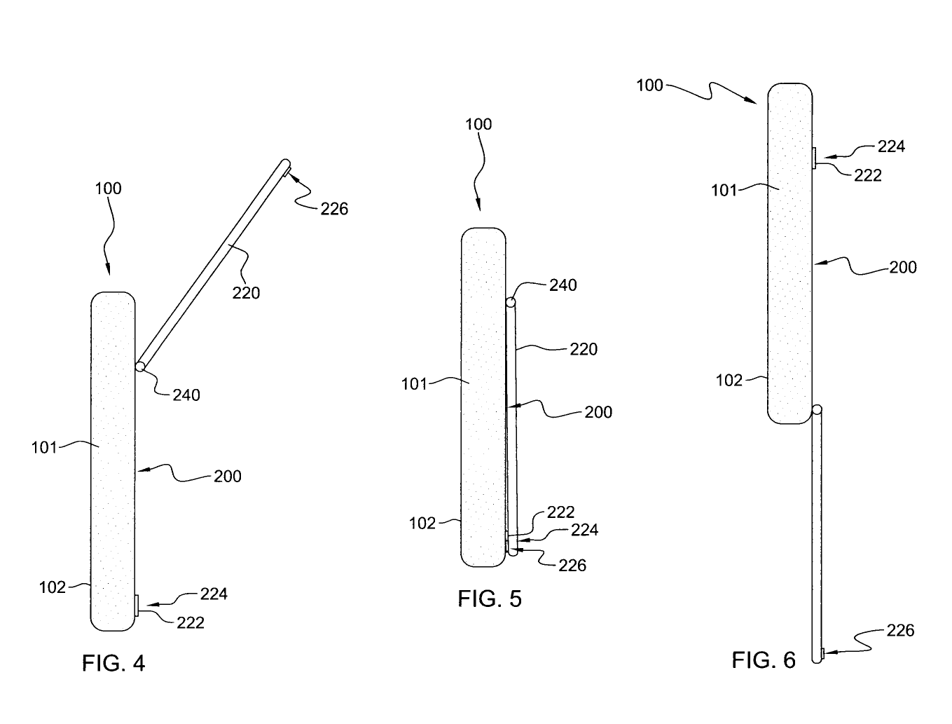

Referring now to FIG. 4, an alternative embodiment of cellular phone cover 101 and cellular phone system 100 is shown. In this embodiment, a hinge 240 is formed between shield 220 and sheath 102. Hinge 240 allows a user to move shield 220 to have unobscured access to mirror 200. It is contemplated that shield 220 may be solid, clear, transparent, translucent, tinted or opaque. Shield 220 may be moved to an open position as seen in FIG. 4 by pivoting about hinge 240. It is contemplated that, in one embodiment, shield 220 may be biased such that it remains in an open position. It is contemplated that shield 220 may be biased with a spring. The movement of shield 220 about hinge 240 allows the user to have direct access to mirror 200, removing any unwanted effects or alteration in image that may be due to the shield being placed between mirror 200 and the user. The spring biasing of shield 220 may allow use of the mirror without the mirror accidentally closing. Additionally, spring biasing to an open position may increase the ease in using the mirror with one hand, leaving the other hand free to apply makeup or perform another task. It is contemplated that, in one embodiment, hinge 240 may be formed of the same material as sheath 102. In another embodiment, it is contemplated that sheath 102 and hinge 240 are formed from different materials.

Referring now to FIG. 5, an alternative embodiment of cellular phone cover 101 and cellular phone system 100 is shown where shield 220 is pivoted about hinge 240 to a closed position. In this embodiment, mirror 200 may be protected from scratches and other damage by the placement of shield 220 against sheath 102. It is contemplated that shield 220 may be held in a closed position by a securing mechanism 222. It is contemplated that securing mechanism 222 may be comprised of a first portion 224, attached to sheath 102, and a second portion 226 attached to shield 220. It is contemplated that securing mechanism 222 may be a snap, VELCRO®, hook-and-loop, sliding lock, or other known locking mechanism. For example purposes first portion 224 may be a male portion of a snap, and second portion 226 may be a female portion of a snap. Shield 220 may be secured in place when first portion 224 is secured to second portion 226.

Now referring to FIG. 6, an alternative embodiment of cellular phone cover 101 and cellular phone system 100 is shown where hinge 240 is located at the bottom of the shield. Hinge 240 is shown in an open position such that shield 220 does not obscure mirror 200. It is contemplated that when sheath 102 is maintained in this upright position, gravity may maintain hinge 240, mirror 200 and shield 220 in the open position. This embodiment provides another manner in which shield 220 may be positioned such that a user may manipulate the mirror 200 with one hand.

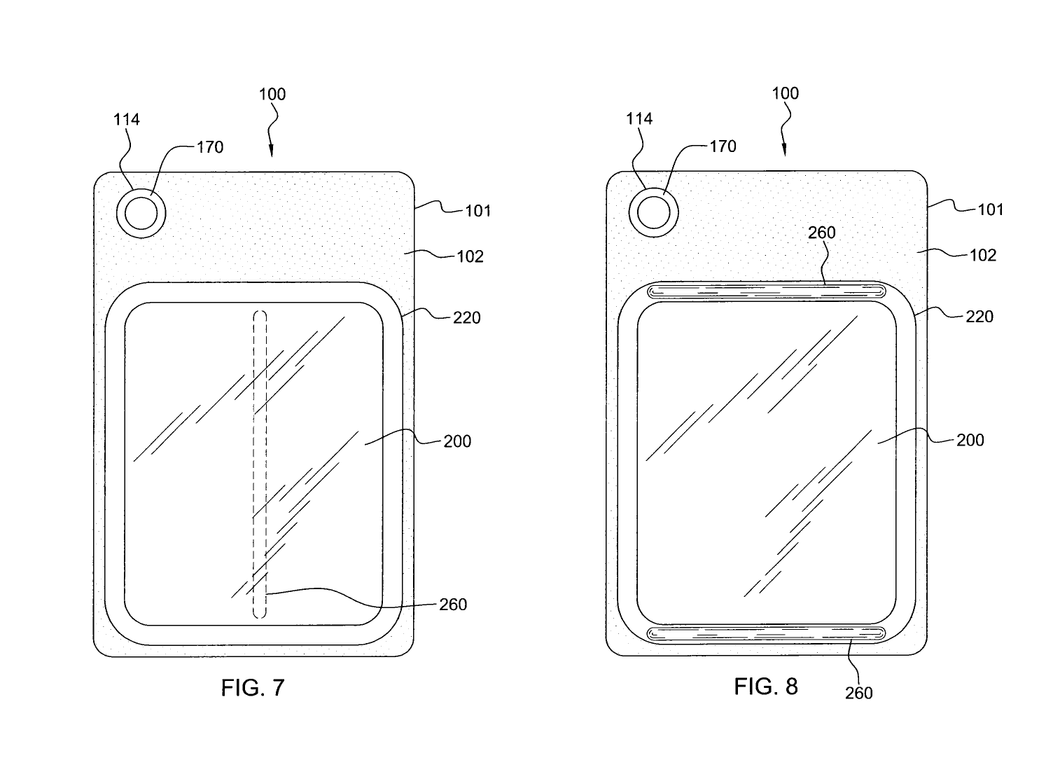

Now referring to FIG. 7, an alternative embodiment of cellular phone cover 101 and cellular phone system 100 is shown where a light 260 has been integrated into sheath 102. In the embodiment shown in FIG. 7, light 260 is shown positioned behind mirror 200 to provide backlighting. It is contemplated that light 260 may allow use of mirror 200 without an additional light source. In one embodiment, it is contemplated that mirror 200 is a one-way mirror that permits light 260 to adequately illuminate the user through mirror 200. It is also contemplated that other types of mirrors may be suitably used for mirror 200 such that light 260, when positioned behind mirror 200, illuminates mirror 200. The placement of light 260 behind mirror 200 is contemplated to also reduce or eliminate the effects of shadows when a light source is located behind the user.

Referring now to FIG. 8, an alternative embodiment of cellular phone cover 101 and cellular phone system 100 is shown. In this embodiment lights 260 are shown above and below mirror 200. This is one example of how light 260 may be located about the perimeter of the mirror. It is contemplated that lights 260 may be provided on one or more sides of mirror 200. It is contemplated that lights 260 may completely surround mirror 200. The embodiment shown in FIG. 8 is for example purposes only. The positioning of lights around the perimeter 260 is another means of allowing use of mirror 200 without an additional light source or reducing the effects of shadow.

It is contemplated that light 260 may be powered by a battery or other energy source in cellular phone cover 101. It is also contemplated that light 260 may be powered by the battery or energy source of phone 170. It is contemplated that, in any of the embodiments, light 260 may be an LED, other type of diode, incandescent, halogen, fluorescent, or other type of known light.

In the embodiments shown in FIG. 7 and FIG. 8, hinge 240 is not formed between shield 220 and sheath 102. However, it is contemplated that embodiments where hinge 240 is formed between shield 220 and sheath 102, as in FIGS. 4-6, may also include light 260. It is further contemplated that, in the embodiments including hinge 240 and light 260, light 260 may be turned on when hinge 240 and shield 220 are placed in a open position. Additionally, a switch or button may be provided on sheath 102 that may be activated to turn on light 260 and deactivated to turn off light 260. Thus, the user may have the ability to control the light source.

It is contemplated that the cellular phone cover 101 may be comprised of, for example purposes, a hard plastic, soft plastic, rubber material, leather, simulated leather, vinyl or other known flexible or inflexible protecting material. It should be understood that other materials would be suitable for the cellular phone cover 101 and are contemplated to be a part of the invention. It is further contemplated the separate elements of the cellular phone cover 101 may be comprised of different materials. For example purposes, sheath 102 may be comprised of soft plastic or rubber material and shield 220 may be comprised of a hard plastic material. It is contemplated that cellular phone cover 101 and cellular phone system 100 are both capable of protecting mirror 220 and cellular phone 170. Further it is contemplated that cellular phone cover 101 and cellular phone system 100 both reduce the clutter that may be carried by an individual. Additional benefit may be provided by light 260, allowing use of a mirror without a separate light source, and reducing the effect of shadows in the event that there is a separate light source.

While embodiments of the invention have been illustrated and described in detail in the disclosure, the disclosure is to be considered as illustrative and not restrictive in character. All changes and modifications that come within the spirit of the invention are to be considered within the scope of the disclosure.

What is claimed is:

1. A cellular phone cover, comprising:
a sheath configured to receive and retain a cellular phone, the sheath being configured with an opening to allow unobstructed access to a user interface of the phone;
a mirror attached to the sheath; and
a shield, positioned to protect the mirror from scratches and other damage, attached to the sheath.

2. The cellular phone cover of claim 1, wherein:
the mirror is positioned on a surface of the sheath, and wherein a back side of the mirror faces the cellular phone when the phone is received and retained in the sheath.

3. The cellular phone cover of claim 2, further comprising:
a hinge formed between the shield and the sheath.

4. The cellular phone cover of claim 1, further comprising:
an aperture formed in the sheath to allow for unhindered use of a camera integrated into the cellular phone.

5. The cellular phone cover of claim 4, further comprising:
one or more apertures formed on the sheath to allow access to one or more sockets formed on the cellular phone.

6. The cellular phone cover of claim 3, wherein:
the hinge is located on the bottom of the shield when the phone is received and retained within the sheath and in an upright position to allow gravity to maintain the mirror in an open position.

7. The cellular phone cover of claim 2, further comprising:
a light for illuminating the mirror, integrated into the sheath.

8. The cellular phone cover of claim 6, wherein:
the light is positioned behind the mirror.

9. The cellular phone cover of claim 7, wherein:
the light is located about the perimeter of the mirror.

10. A cellular phone system, comprising:
a cellular phone;
a sheath covering the cellular phone, the sheath configured with an opening to allow unobstructed access to a user interface of the phone;
a mirror attached to the sheath; and
a shield, positioned to protect the mirror from scratches and other damage, attached to the sheath.

11. The cellular phone system of claim 10, wherein:
the mirror is positioned on a surface of the sheath, and wherein a back side of the mirror faces the cellular phone when the phone is received and retained in the sheath.

12. The cellular phone system of claim 11, further comprising:
a hinge formed between the shield and the sheath.

13. The cellular phone system of claim 11, further comprising:
an aperture formed in the sheath to allow for unhindered use of a camera integrated into the cellular phone.

14. The cellular phone system of claim 13, further comprising:
one or more apertures formed on the sheath to allow access to one or more sockets formed on the cellular phone.

15. The cellular phone system of claim 12, wherein:
the hinge is located on the bottom of the shield when the phone is received and retained within the sheath and in an upright position to allow gravity to maintain the mirror in an open position.

16. The cellular phone system of claim 11, further comprising:
a light for illuminating the mirror, integrated into the sheath.

17. The cellular phone system of claim 16, wherein:
the light is positioned behind the mirror.

18. The cellular phone system of claim 17, wherein:
the light is located about the perimeter of the mirror.

19. A method of adapting a cellular phone, comprising:
providing a sheath for covering a cellular pone, the sheath configured with an opening to allow unobstructed access to a user interface of the phone;
attaching a mirror to the sheath;
providing a shield positioned to protect the mirror from scratches and other damage.

20. The method of claim 19, further comprising:
positioning the mirror on the surface of the sheath, wherein a back side of the mirror faces the cellular phone.
